(19) United States
(12) Patent Application Publication
(10) Pub. No.: US 2005/0081695 A1
(43) Pub. Date: Apr. 21, 2005

(54) Punch pin structure and cutting tool of punching apparatus

(76) Inventor: Pei-Yuan Lee, Taipei (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/898,745

(22) Filed: Jul. 26, 2004

(30) Foreign Application Priority Data
Oct. 17, 2003 (TW) 92128944

(51) Int. Cl. B26F 1/14

(52) U.S. Cl. 83/687; 83/689

(57) ABSTRACT

A punch pin structure includes a pin body, a first piercing end, a second piercing end and a cutting member. The first piercing end extends from the bottom of the pin body. The second piercing end extends from the bottom of the pin body and is separate from the first piercing end. The cutting member is disposed at the bottom of the pin body between the first piercing end and the second piercing end. The first piercing end is in contact with the object to be punched prior to the cutting member and the second piercing end in response to a punching operation.

### FIELD OF THE INVENTION

The present invention relates to a punch pin structure and a cutting tool, and more particularly to a punch pin structure and a cutting tool of a punching apparatus for creating holes in paper sheets.

### BACKGROUND OF THE INVENTION

A punching apparatus is widely used to punch a stack of paper sheets to create neat holes at a side of the paper sheets so as to facilitate filing. FIG. 1 illustrates a cutting tool of a conventional punching apparatus. The cutting tool comprises a punching body 1 and a plurality of punch pins 10. These punch pins 10 are located in parallel to one another and different in length. When a punching operation is performed, these punch pins 10 are forced to punch through the stack of paper sheets (not shown) in batch according to length distribution. That is, the longest punch pins are first work on the paper and then followed by the shorter ones until all the punch pins penetrate through the paper to create an equivalent number of holes. As is understood, the arrangement of various pin lengths distributes the exertion of punching force over different time points so as to make the punching operation easy.

Since the rectangular cutting edge 11 of each punch pin 10 in the conventional punch apparatus of FIG. 1 has a flat bottom surface, the contact area of the bottom surface of the cutting edges 11 with the paper sheets to be punched is so large that the punching force exerted on the punch pins 10 is undesirably scattered. In other words, many efforts will be required to perforate the paper sheets. In order to save effort, the configuration of the lower end of each punch pin is modified to have a wedged bottom in another conventional punching apparatus. As shown in FIG. 2, the punch pin comprises a pin body 2, two piercing tips 21 and a V-shaped groove 20. The two piercing tips 21 are symmetrically arranged at opposite sides of the V-shaped groove 20. When a punching operation is performed, it will be the piercing tips 21 first in contact with the paper to be punched. Therefore, the punching force can be concentrated on the tips 21 rather than scattered to the entire bottom surface. By this way, the paper can be perforated in an effort-saving manner compared to the punch pin of FIG. 1. The punch-pin structure, however, raise a new issue. After the tips 21 perforate the paper sheets, paper crumbs will enter the V-shaped groove 20 and likely choke the groove 20. The crumbs, if nor removed, will adversely affect further punching operations.

### SUMMARY OF THE INVENTION

The present invention provides a punch pin structure and a cutting tool of a punching apparatus, which can be operated to perforate the paper sheets in an effort-saving manner while readily removing the paper crumbs cut off by the punching apparatus.

In accordance with a first aspect of the present invention, there is provided a punch pin structure of a punching apparatus. The punch pin structure comprises a pin body, a first piercing end, a second piercing end and a cutting member. The first piercing end extends from the bottom of the pin body. The second piercing end extends from the bottom of the pin body and is separate from the first piercing end. The cutting member is disposed at the bottom of the pin body between the first piercing end and the second piercing end. The first piercing end is in contact with the object to be punched prior to the cutting member and the second piercing end in response to a punching operation.

In an embodiment, the cutting member is a concave bottom surface of the pin body comprising a first cutting plane adjacent to the first piercing end and a second cutting plane adjacent to the second piercing end.

In an embodiment, the slope of the first cutting plane is greater than that of the second cutting plane.

In an embodiment, the length of the first cutting plane is smaller than that of the second cutting plane.

In an embodiment, the first piercing end is an edge of the first cutting plane, and the second piercing end is an edge of the second cutting plane.

In an embodiment, the pin body is tapered from bottom to top.

In an embodiment, the cutting member includes a concave surface with sharp edges.

In an embodiment, the first and second piercing ends and the cutting member are integrally formed with the pin body.

In accordance with a second aspect of the present invention, there is provided a punch pin structure of a punching apparatus. The punch pin structure comprises a pin body, a first piercing end and a second piercing end. The pin body has a concave cutting surface. The first piercing end extends from the concave cutting surface of the pin body. The second piercing end extends from the concave cutting surface of the pin body and is separate from the first piercing end. The first piercing end is in contact with the object to be punched prior to the second piercing end in response to a punching operation.

In an embodiment, the most recessed point of the concave cutting surface is closer to the first piercing end than the second piercing end.

In accordance with a third aspect of the present invention, there is provided a cutting tool for punching holes in an object. The cutting tool comprises a punching plate and a plurality of punch pins. The punch pins extend from a side of the punching plate and are parallel to one another. At least one of the punch pins comprises at the bottom thereof a first piercing end, a second piercing end and a concave cutting surface disposed between the first piercing end and the second piercing end. The first piercing end is more protrudent than the second piercing end so that the object to be punched is firstly pierced by the first piercing end and the second piercing end successively, and perforated by the cutting member.

In an embodiment, the punch pins differentially protrude from the side of the punching plate in order that the punch pins punch the object in batch.

In an embodiment, two end punch pins and a middle punch pin are the most protrudent among the punch pins, and a gradient from the most to the least protrudent punch pins is formed between either of the two end punch pins and the middle punch pin.

In an embodiment, the punch pins are distributed symmetrically in respect to the middle punch pin.

The present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating the perspective view of a cutting tool of a conventional punching apparatus;

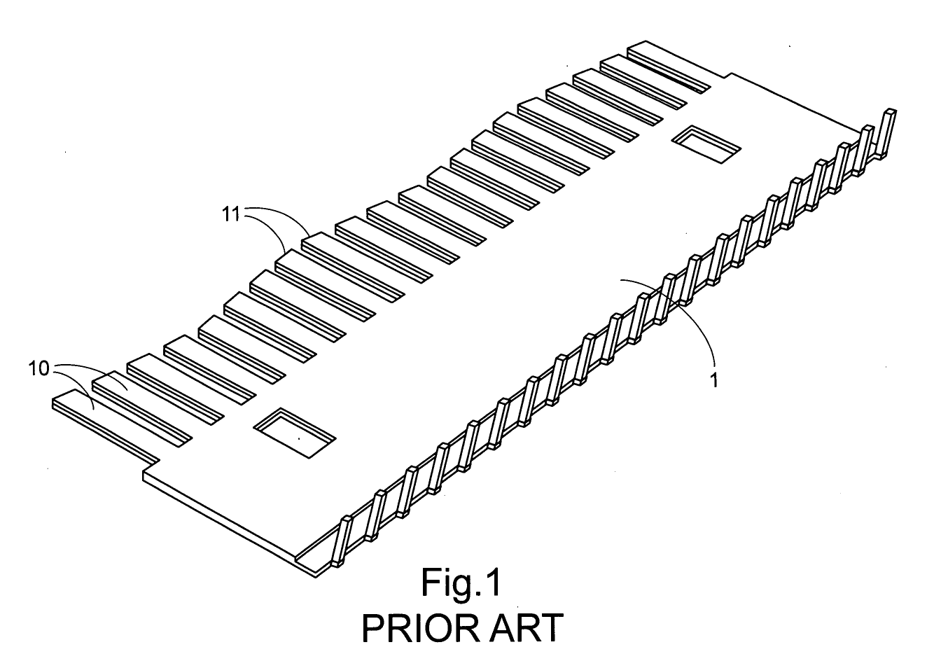

FIG. 2 is a schematic diagram illustrating the side view of a punch pin structure of a cutting tool according to prior art;

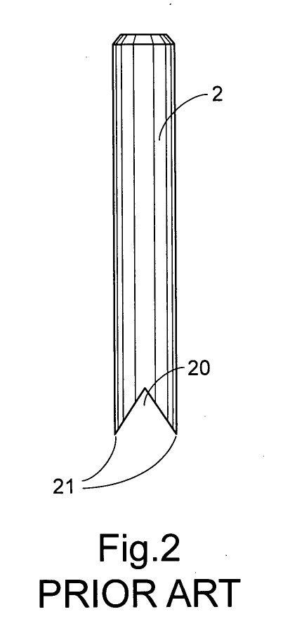

FIG. 3 is a schematic perspective resolving diagram showing the cutting mechanism of a punching apparatus comprising a preferred embodiment of a cutting tool according to the present invention; and

FIG. 4 is a partially enlarged side view of an embodiment of the punch pin structure used in the cutting tool of FIG. 3.

### DETAILED DESCRIPTION OF THE PREFERRED EMBODIMENT

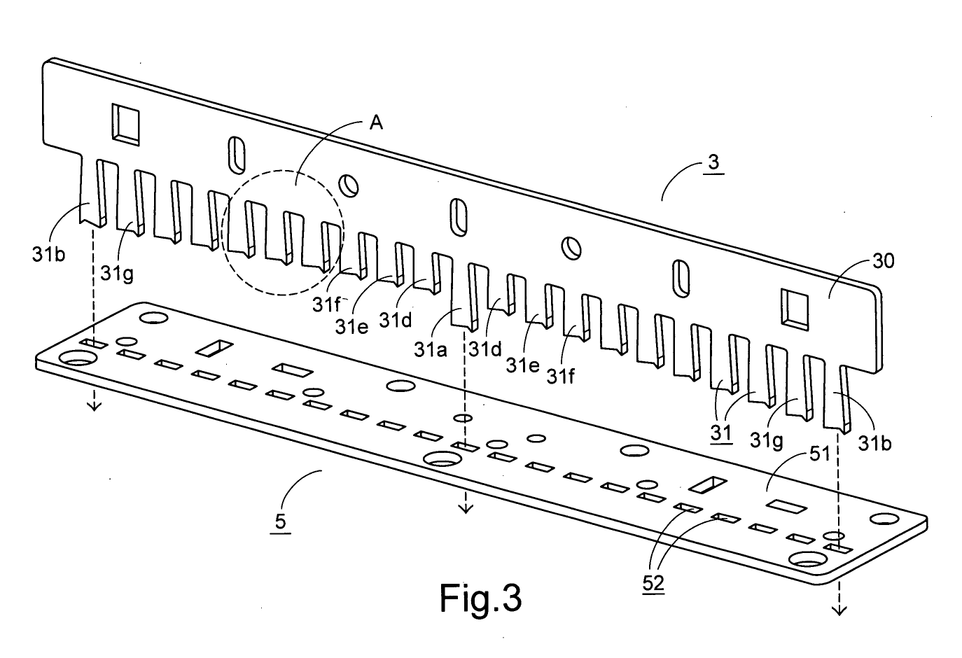

Hereinafter, an embodiment of a cutting tool for use in a punching apparatus to create holes in an object such as paper will be illustrated. Referring to FIG. 3, the punching apparatus comprises a cutting tool 3 and a die plate 5. The cutting tool 3 comprises a punching plate 30 and a plurality of punch pins 31 extending from the punching plate 30. The object (not shown) to be punched is placed on the die plate 5 including a plurality of punching holes 52 and lying under the punch pins 31. By pushing the punching plate 30 down to have the punch pins 31 penetrate through corresponding punching holes 52, the object will be perforated. The punch pins 31 are arranged in parallel to one another and differentially protrude from the bottom side of the punching plate 30 so as to punch the object in batch. In this embodiment, the punch pins 31 are distributed symmetrically in respect to the middle punch pin 31a. The middle punch pin 31a and the end punch pins 31b are the most protrudent among the punch pins 31. A gradient from the most to the least protrudent punch pins is formed between the end punch pin 31b and the middle punch pin 31a. In other words, the punch pin 31d is shorter than the punch pin 31e, which is shorter than the punch pin 31f, and so on, and the punch pin 31g is the longest one in the gradient.

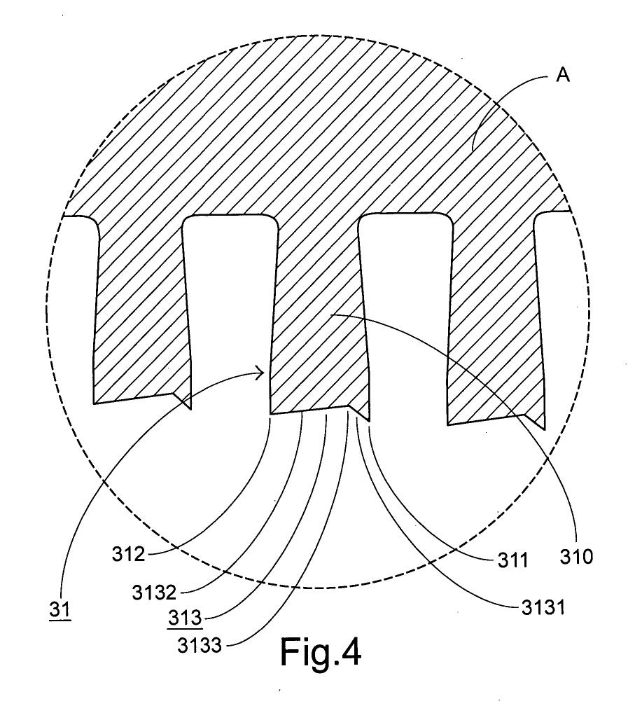

According to the present invention, the punch pin structure is well designed to perforate the object in an effort-saving manner while readily removing the crumbs cut off by the punching apparatus. As shown in FIG. 4, for each punch pin 31, there are a first piercing end 311 and a second piercing end 312 extending from a pin body 310. The pin body 310 is tapered from bottom to top and has a concave bottom surface 313 between the first and second piercing ends 311 and 312. The concave bottom surface 313 functioning as a cutting face comprises a first cutting plane 3131 adjacent to the first piercing end 311 and a second cutting plane 3132 adjacent to the second piercing end 312, which are asymmetrically arranged. In this embodiment, the first cutting plane 3131 has a greater slope but smaller length than the second cutting plane 3132. In other words, the most recessed point 3133 of the concave cutting surface is closer to the first piercing end 311 than the second piercing end 312.

The punching mechanism implemented by the cutting tool according to the present invention will be illustrated in greater details as follows by giving the embodiment as shown in FIGS. 3 and 4 as an example. FIG. 4 is a partially enlarged view of the portion A of the cutting tool in FIG. 3.

In response to the downward push of the punching plate 30, the object, e.g. paper sheets, positioned on the supporting surface 51 of the die plate 5 is firstly pierced by the first piercing ends 311 of the three longest punch pins, i.e. the middle punch pin 31a and the end punch pins 31b. Successively, the paper sheets are pierced by the second piercing ends 312 of these punch pins 31a and 31b and then perforated by the concave cutting surfaces 313. Afterwards, the paper sheets are pierced by the first piercing ends 311 and the second piercing ends 312 of the punch pins 3g adjacent to the end punch pins 31b successively, and then perforated by the concave cutting surfaces 313. Similar piercing and perforating operations are done from the longest punch pins to the shortest ones, and finally the punch pins 31d adjacent to the middle punch pins 31a perforate the paper sheets, thereby creating an equivalent number of holes on the paper sheets.

Since the second piercing ends 312 is less protrudent than the first piercing ends 311, the paper crumbs cut off by the cutting tool can be easily removed via the gap under the second piercing ends 312. Therefore, the above mentioned punch pin structure facilitates cutting and crumb-removing during the punching operation. Moreover, the uneven arrangement of the punch pins and the staggered feature of the piercing ends of each punch pin distribute the exertion of punching force over different time points so as to save laboring.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A punch pin structure of a punching apparatus, comprising:
a pin body;
a first piercing end extending from the bottom of said pin body;
a second piercing end extending from the bottom of said pin body and separate from said first piercing end; and
a cutting member disposed at the bottom of said pin body between said first piercing end and said second piercing end,
wherein said first piercing end is in contact with the object to be punched prior to said cutting member and said second piercing end in response to a punching operation.

2. The punch pin structure according to claim 1 wherein said cutting member is a concave bottom surface of said pin body comprising a first cutting plane adjacent to said first piercing end and a second cutting plane adjacent to said second piercing end.

3. The punch pin structure according to claim 2 wherein the slope of said first cutting plane is greater than that of said second cutting plane.

4. The punch pin structure according to claim 2 wherein the length of said first cutting plane is smaller than that of said second cutting plane.

5. The punch pin structure according to claim 2 wherein said first piercing end is an edge of said first cutting plane, and said second piercing end is an edge of said second cutting plane.

6. The punch pin structure according to claim 1 wherein said pin body is tapered from bottom to top.

7. The punch pin structure according to claim 1 wherein said cutting member includes a concave surface with sharp edges.

8. The punch pin structure according to claim 1 wherein said first and second piercing ends and said cutting member are integrally formed with said pin body.

9. A punch pin structure of a punching apparatus, comprising:
a pin body having a concave cutting surface;
a first piercing end extending from said concave cutting surface of said pin body; and
a second piercing end extending from said concave cutting surface of said pin body and separate from said first piercing end,
wherein said first piercing end is in contact with the object to be punched prior to said second piercing end in response to a punching operation.

10. The punch pin structure according to claim 9 wherein the most recessed point of said concave cutting surface is closer to said first piercing end than said second piercing end.

11. A cutting tool for punching holes in an object, comprising:
a punching plate; and
a plurality of punch pins extending from a side of said punching plate and parallel to one another, at least one of said punch pins comprising at the bottom thereof a first piercing end, a second piercing end and a concave cutting surface disposed between said first piercing end and said second piercing end,
wherein said first piercing end is more protrudent than said second piercing end so that the object to be punched is firstly pierced by said first piercing end and said second piercing end successively, and perforated by said cutting member.

12. The cutting tool according to claim 11 wherein said punch pins differentially protrude from said side of said punching plate in order that said punch pins punch the object in batch.

13. The cutting tool according to claim 11 wherein two end punch pins and a middle punch pin are the most protrudent among said punch pins, and a gradient from the most to the least protrudent punch pins is formed between either of said two end punch pins and said middle punch pin.

14. The cutting tool according to claim 13 wherein said punch pins are distributed symmetrically in respect to said middle punch pin.

15. The punch pin structure according to claim 11 wherein said concave cutting surface of said pin body comprises a first cutting plane adjacent to said first piercing end and a second cutting plane adjacent to said second piercing end.

16. The punch pin structure according to claim 15 wherein the slope of said first cutting plane is greater than that of said second cutting plane.

17. The punch pin structure according to claim 15 wherein the length of said first cutting plane is smaller than that of said second cutting plane.

18. The punch pin structure according to claim 15 wherein said first piercing end is an edge of said first cutting plane, and said second piercing end is an edge of said second cutting plane.

19. The punch pin structure according to claim 11 wherein said pin body is tapered from bottom to top.

20. The punch pin structure according to claim 11 wherein said first and second piercing ends and said cutting member are integrally formed with said pin body.
